(19) United States
(12) Patent Application Publication
(10) Pub. No.: US 2016/0311162 A1
(43) Pub. Date: Oct. 27, 2016

(54) NOVEL COLOR 3D PRINTER BASED ON ENERGY-CURABLE COLOR COATING ON TRANSPARENT OR TRANSLUCENT BASE MATERIAL

(71) Applicant: WIN-HALL TECH SDN BHD, Simpang Ampat (MY)

(72) Inventors: Yong Yu LIU, Chiliwack (CA); Woo Seow Keat THOMAS, Bayan Lepas (MY)

(21) Appl. No.: 15/137,116

(22) Filed: Apr. 25, 2016

Related U.S. Application Data
(60) Provisional application No. 62/152,190, filed on Apr. 24, 2015.

(51) Int. Cl. B29C 67/00

(52) U.S. Cl. CPC B29C 67/0059; B29C 35/0805

(57) ABSTRACT

The invention relates generally to a color 3D printer based on ultraviolet (UV) energy-curable high quality color coating on transparent or translucent base material. More particularly, the invention deals with the use of a Light Emitting Diode (LED) UV-curable ink-jet printing technique with high spatial and color selectivity for coating the base material deposited using additive manufacturing technology in a repeated process for building color 3D object. Each layer of the deposited base material is selectively colored with 2D pattern based on the required 3D color representation of the 3D object, either effectively inside the build volume or on the build surface, or both effectively inside the build volume and on the build surface of the 3D object. The colored 3D object formed using the method described in the present invention is capable of achieving high quality color rendering at relatively high spatial and color resolutions.

### BACKGROUND OF THE INVENTION

1. Field of the Invention

The invention relates generally to a color 3D printer based on ultraviolet (UV) energy-curable high quality color coating on transparent or translucent base material. More particularly, the invention deals with the use of a Light Emitting Diode (LED) UV-curable ink-jet printing technique with high spatial and color selectivity for coating the base material deposited using additive manufacturing technology in a repeated process for building color 3D object. Each layer of the deposited base material is selectively colored with 2D pattern based on the required 3D color representation of the 3D object, either effectively inside the build volume or on the build surface, or both effectively inside the build volume and on the build surface of the 3D object. The colored 3D object formed using the method described in the present invention is capable of achieving high quality color rendering at relatively high spatial and color resolutions.

2. Description of the Background

In the context of 3D printing, which commonly known as rapid prototyping or rapid manufacturing are generally referred as additive manufacturing technology which relates to two types of processes namely Selective Laser Sintering (SLS) and Fused Deposition Modeling (FDM), also commonly known as Fused Filament Fabrication (FFF). The descriptions of a number of different techniques related to producing colored 3D objects as disclosed in prior art have been outlined in US 2014/0134334 A1, hence most of these techniques will not be discussed again here except those that are closely related to the present invention, which in particular, on rapid prototyping systems of prior art that employ 2D ink-jet technology for selective color coating on base material layers of the object being built.

In the process described in US2004/0251574, it has the advantage of permitting highly selective coating by first dispensing a layer of build material such as powder or slurry followed by selective printing with an ink and binder. However, this technique has the disadvantage of being unable to achieve uniform color definition or bright coloring. In addition, the build process involves a series of steps from spreading and compressing the build material for obtaining the desired thickness, coloring (for example using ink-jet) and binding (for example using UV-curable resin) the build material, and finally brushing away the extra powder and cleaning the object at the end of the build process. This requires a relatively complicated system construction with tedious operation and handling of build material.

In the process described in EP1558440, the method works under the principles that the object can be viewed, conceptually, as a series of nested shells of different colors which visually showing the actual color of the object as a combination of the colors of the nested shells. This process may have the disadvantage of having complicated algorithms for calculating the desired combination of colors under different physical and/or optical conditions in order to form the nested shells of different colors for accurate color representation of the built object. In addition, there is no description about how and what kind of ink should be used for coating the based material that has solidified before the ink is applied.

In general, while some of the systems as disclosed in prior art involve complicated system construction with the need of color binding material, others involve tedious material handling (such as powder or liquid based resin) and complicated color rendering algorithms. The cost of such complicated systems is also expected to be relatively high.

Thus, a color 3D printer of FFF technology having high quality color rendering with high spatial and color resolutions that require relatively simple system construction, fewer operation with ease of material handling and yet affordable is desired.

### SUMMARY OF INVENTION

It is therefore, an object of the present invention to provide a color 3D printing method for producing high quality color rendering of the 3D object.

It is another object of the present invention to provide a 3D printer capable of providing high color definition to the build object with high spatial resolution.

It is yet another object of the present invention to provide a 3D printer that is based on relatively simple system construction with lesser system components.

It is still another object of the present invention to provide a 3D printer with fewer operations with ease of build material handling.

It is a further object of the present invention to provide a 3D printer that is capable of providing color rendering either effectively inside the build volume or on the build surface, or both effectively inside the build volume and on the build surface of the 3D object.

It is yet a further object of the present invention to provide a 3D printer that is more affordable.

Briefly, the preferred embodiment of the present invention is a color 3D printing method comprising a material dispenser such as an extrusion-based material deposition device as in FFF technology, and an energy-curable color coating device such as the LED UV-curable color printing device, such technology of which is used on HP Scitex UV-curable printers manufactured by Hewlett-Packard Development Company, and Roland VersaUV® LEC series UV-curable printers by Roland DGA Corporation.

In a further preferred embodiment, the extrusion-based material is a transparent or translucent polymer such as that of transparent or clear polylactic acid (PLA) biopolymer commonly used in 3D printing industry. One of such material can be produced using the technique disclosed in U.S. Pat. No. 7,507,561 B2.

In still a further preferred embodiment, the colorant is based on LED UV-curable inks. Two examples of such product already in the market are Scitex UV-curable inks introduced by Hewlett-Packard Development Company, and Roland ECO-UV curable inks by Roland DGA Corporation. As UV-curable inks can be used with almost any type of conventional media including plastic, glass, ceramics and more, the technique as disclosed in the present invention can be extended for use with different build materials.

### IN THE DRAWING

FIG. 1 is a two dimensional view illustrating a preferred embodiment of the present invention.

FIG. 2 shows the pictures demonstrating the concept of building the color 3D object of the present invention.

FIG. 3 shows the graphical representation of a color 3D object that can be produced using the printing technique described by the present invention.

### DESCRIPTION OF THE PREFERRED EMBODIMENT

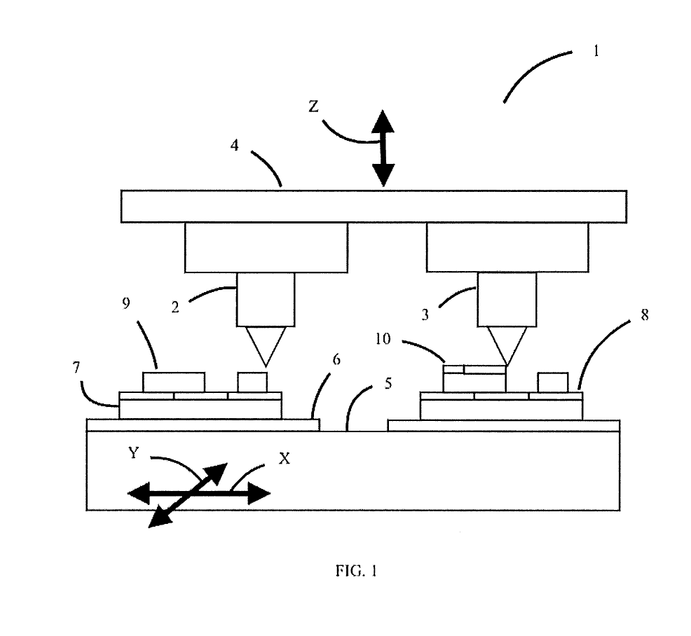

In FIG. 1, the color 3D printing system 1 that provides the means for selective color coating on each layer of build material comprising a material extruder head 2 of technology such as the one disclosed in U.S. Pat. No. 5,121,329, and an LED UV-curable ink-jet print head 3 of technology such as the one disclosed in U.S. Pat. No. 6,454,405 B1. In a typical embodiment of the present invention, the material extruder head 2 and the UV-curable ink-jet print head 3 are mounted on a common support referred to as the material and print head Z positioning stage 4 allowing them to move in the vertical direction thus provide the means for controlling the thickness of material to be deposited by material extruder 2. The build object XY positioning stage 5 that moves in perpendicular direction to the Z positioning stage 4 allows the extrusion of build material with a 2D cross sectional pattern to be formed. The material and print head Z positioning stage 4 is also referred to as Z positioning stage 4 and the build object XY positioning stage 5 is also referred to as XY positioning stage 5 in this document. Another purpose of the XY positioning stage 5 is to allow the material holding plate 6, typically made of glass and the build object that is laid onto it to be moved between the corresponding positions below the material extruder 2 and UV-curable ink-jet print head 3. The material holding plate 6 is mounted firmly on top of XY positioning stage 5. The material extruder head 2 and UV-curable ink-jet print head 3 are separated horizontally, typically with a distance at least equal or larger than the diameter of the desired maximum diameter of the build object printable using the system 1. In order to ensure that the material extruder 2 and UV-curable ink-jet print head 3 are printing at appropriate height, some vertical alignment means should be included by using position sensitive sensors such as mechanical limit switches or optical limit switches with fine vertical adjustment of the material extruder 2 and UV-curable ink-jet print head 3. The said position sensitive sensors also are used to avoid said material extruder head and UV curable ink-jet print head to crash with said holder and for performing auto-height-leveling with respect to the surface of the said holder. Since this is obvious to those skilled in the art, it is beyond the scope of the present invention to provide the height alignment method in details. It is also beyond the scope of the present invention to describe the material extruder 2 and UV-curable ink-jet print head 3 of prior art. For the purpose of describing the printing process, the height of material extruder 2 and UV-curable ink-jet print head 3 are assumed to have properly adjusted.

In a typical process of building a 3D object, the 3D computer representation of the object is first sliced into multiple cross-sectional layers of 2D patterns of smaller thickness. The computer data of the sliced 2D patterns are sent layer by layer to the printing system 1 for forming the color 3D object as described below.

In the beginning of a typical 3D color object printing process of the present invention, the Z positioning stage 4 is moved all the way up to ensure that XY positioning stage 5 is free to move without obstacle. The material holding plate 6 is then moved to the vicinity below the material extruder 2 by moving the XY positioning stage 5. The Z positioning stage 4 is then lowered slowly such that the material extruder head 2 is moved towards and finally in contact with the material holder 6. A typical auto-leveling is performed to ensure that the Z positioning stage 4 is automatically aligned to have a fixed distance from the surface of the material holder 6 across the whole trajectory of XY positioning stage 5. The Z positioning stage 4 is then moved up a small distance about the thickness of the first build material layer to be deposited. This distance is typically between 25 micrometers to 300 micrometers and is referred to as the layer thickness hereinafter. The 2D position information for creating the cross-sectional pattern corresponding to the build material layer 7 is sent electronically to the printer system 1 for controlling the material extruder 2 and XY positioning stage 5. This is then followed by moving the XY positioning stage 5 such that the lower tip of material extruder 2 corresponds to the starting point of the 2D pattern to be formed. The first layer of build material layer 7 is then deposited using the extruder head 2 by means of controlling the XY positioning stage 5 thus forming the first 2D cross sectional pattern on the material holding plate 6. Once build material layer 7 is completed, the XY positioning stage 5 is moved such that the material holder 6 together with the build material layer 7 are moved to the corresponding position under the UV-curable ink-jet print head 3. The 2D position and color information for coating the first build material 7 is sent electronically to the printer system 1 for controlling the UV-curable ink-jet print head 3 and XY positioning stage 5. This is followed by moving the XY positioning stage 5 such that the tip of the UV-curable ink-jet print head 3 corresponds to the starting position of the 2D color pattern to be coated. The color coating is then performed using the UV-curable ink-jet print head 3 by means of controlling the XY positioning stage 5 thus forming the color coating layer 8 on top of the material build layer 7. The intense UV light of the UV-curable ink-jet print head 3 ensures that the curable ink is instantly hardened by polymerization (curing) which create a durable color film covering the material layer 7. Upon completion of color coating layer 8, Z positioning stage 4 is moved up by a distance equal to the layer thickness. The XY positioning stage 5 will then move back to the corresponding starting position under the material extruder 2 for extruding a second layer of build material layer 9 directly on top of color coating layer 8. The process continues and repeated for extruding the build material layer 9 and color coating layer 10 and so on until all the layers are printed to form the desired color 3D object.

In a typical embodiment of the present invention, an extruder head and print head alignment procedure can be carried out using test pattern and alignment method such as that described in U.S. Pat. No. 6,726,302 B2. A series of test patterns such as lines and cross-hairs can be used for aligning extruder head 2 and UV-curable print head 3 so that the 2D pattern extruded by the extruder head 2 is properly aligned with the corresponding 2D color pattern coated by the UV-curable print head 3. As such alignment method is commonly used and known to those skillful in the field, detailed description is beyond the scope of the present invention.

In yet another typical embodiment, a digital camera (not shown) can be attached to the Z positioning stage 4 in order to accomplish the alignment automatically as described herein. After the test patterns are printed as described above, the digital camera is activated for taking images of the test patterns which can then be processed and compared for calculating the X and Y displacement between extruder head 2 and UV-curable print head 3. The print head displacement information can then be applied for the required position compensation in achieving automated alignment of the two print heads.

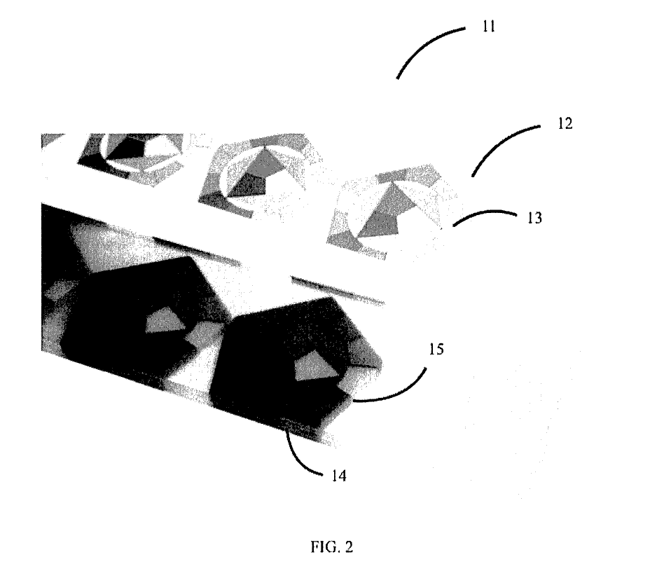

In FIG. 2, the 3D object 11 with a thickness of about 3.9 mm shows a concept demonstration of the present invention. The 3D object is formed by stacking 39 pieces of thin transparent film 12 each with thickness of 0.1 mm to resemble the build material layer extruded with the material extruder head 2 of FIG. 1. Each transparent thin film 12 is printed with 2D pattern 13 using conventional color ink-jet printer to resemble the effect of printing using UV-curable ink-jet print head 3 of FIG. 1. The 3D object 11 in FIG. 2 shows a visible colored surface 14 on the edge of the stacked films as if the color coating were applied on the surface 14. Another demonstration of the concept of the present invention is that the shape and color of pattern 13 printed on transparent film 12 eventually forms the build material 15 inside the volume of the 3D object 11 and is visible to the viewer.

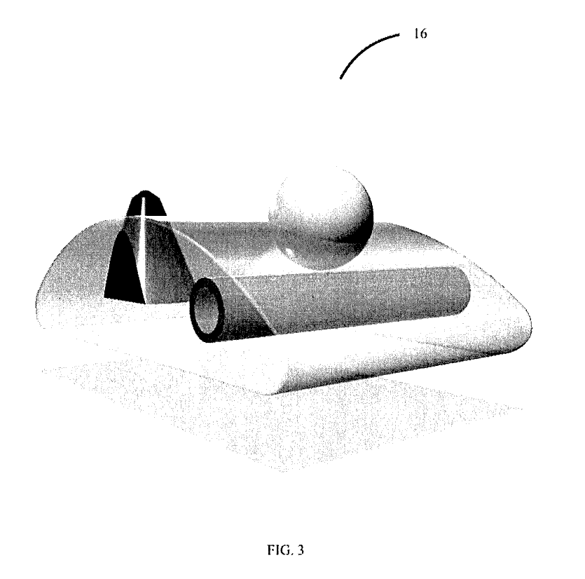

In FIG. 3, a graphical representation of a 3D build object showing different opaque build objects inside the transparent (or translucent) build volume being visible to the viewer. This illustrates a typical 3D object with high quality energy-curable color coating on the said build material allowing for the color rendering to be visible either effectively inside the build volume or on the surface of the resulting said 3D object, or both effectively inside the volume and on the surface of said 3D object, that can be built using the technique described by present invention.

In a typical embodiment of this invention, a clear build material with good optical transparency such as that of transparent PLA material is used to provide good visibility of the printed color layers immediately beneath and on top of each build material layer as well as at the edge surfaces. This will ensure that the printed color to be clearly visible by the viewer, either it is inside or at the surface of the build volume or both inside and at the surface of the build volume which eventually provide a good overall color representation of the 3D object.

An advantage of the present invention is that it provides the means for producing high color definition to the build object with high spatial resolution.

Another advantage of the present invention of that it provides the means for 3D printing that has fewer operation and with ease of handing the build material.

It is also another advantage of the present invention to provide 3D printing that is capable of creating colorful 3D object with color rendering either effectively inside the build volume or on the build surface, or both effectively inside the build volume and on the build surface of the 3D object.

It is still another advantage of the present invention to provide color 3D printing that can be used with different type of transparent or translucent build materials including plastic, glass, ceramics and other materials that are compatible with UV-curable ink.

The present invention has been described in detail with respect to preferred embodiments, and it will now be apparent from the foregoing to those skilled in the art that changes and modification may be made without departing from the invention in its broader aspect, and it is the invention, therefore, in the apparent claims to cover all such changes and modification as fall within the true spirit of the invention.

What is claimed is:

1. A color 3D printing apparatus based on high quality energy-curable color coating on build material, comprising:
(a) a material extruder head for dispensing a build material;
(b) an ink-jet print head for applying color coating on the said build material;
(c) a holder for holding the 3D object;
(d) a material and print head positioning stage for mounting and positioning the said material extruder head and UV-curable ink-jet print head at a minimum distance between them of at least equal to the diameter of the desired maximum diameter of the 3D object and designed to move in vertical up-down direction;
(e) a build object positioning stage for mounting and positioning the said holder and designed to move in a direction that is perpendicular to the material and print head positioning stage below the material extruder and UV-curable ink-jet print head;
wherein said ink-jet print head is UV curable.

2. The system in claim 1, wherein said build material is transparent.

3. The system in claim 1, wherein said build material is translucent.

4. The system in claim 1, wherein the said material extruder head and the UV-curable ink-jet print head is attached with at least one position sensitive sensor.

5. A method of printing and applying color to 3D objects, comprising the steps of:
(a) positioning at least one material and print head positioning stage to the highest level to allow at least one build object position stage to move free horizontally without obstacle;
(b) moving said build object position stage until at least one material holding plate on top of said build object position stage is below at least one material extruder of the material and print head positioning stage;
(c) moving said material and print head positioning stage downwards until said material extruder head is in contact with said material holding plate;
(d) moving said material and print head positioning stage upwards at a distance of the thickness of the first transparent build material layer to be deposited;
(e) moving said build object position stage horizontally while said material extruder depositing said transparent build material according to predetermined 2D position information;
(f) after the first layer is complete, moving said build object position stage horizontally until said material holding plate is under at least one UV-curable ink-jet print head;
(g) moving said material and print head position stage while said UV-curable ink-jet print head performing color coating on said first layer of transparent build material;
(h) steps (a) to (g) is repeated for subsequent layers of transparent build material.

6. A method of printing and applying color to 3D objects, comprising the steps of:
(a) positioning at least one material and print head positioning stage to the highest level to allow at least one build object position stage to move free horizontally without obstacle;
(b) moving said build object position stage until at least one material holding plate on top of said build object position stage is below at least one material extruder of the material and print head positioning stage;
(c) moving said material and print head positioning stage downwards until said material extruder head is in contact with said material holding plate;
(d) moving said material and print head positioning stage upwards at a distance of the thickness of the first translucent build material layer to be deposited;
(e) moving said build object position stage horizontally while said material extruder depositing said translucent build material according to predetermined 2D position information;
(f) after the first layer is complete, moving said build object position stage horizontally until said material holding plate is under at least one UV-curable ink-jet print head;
(g) moving said material and print head position stage while said UV-curable ink-jet print head performing color coating on said first layer of translucent build material;
(h) steps (a) to (g) is repeated for subsequent layers of translucent build material.
